(19) United States
(12) Patent Application Publication
(10) Pub. No.: US 2026/0305573 A1
(43) Pub. Date: Oct. 8, 2026

(54) Equine Wrap with Medical Access Opening

(71) Applicant: Chris Ray, Milsap, TX (US)

(72) Inventor: Chris Ray, Milsap, TX (US)

(21) Appl. No.: 19/172,867

(22) Filed: Apr. 8, 2025

(51) Int. Cl. A01K 13/00

(52) U.S. Cl. CPC A01K 13/008

(57) ABSTRACT

An equine wrap comprises a fabric that includes contours that conform to a shape of a horse. At least one medical access opening is positioned in the fabric to align with an intravenous location of the horse. At least one fastener is adjacent to the at least one medical access opening.

### BACKGROUND

### 1. Field of the Invention

The present application relates to medical equipment used for horses, and more particularly to an equine wrap with at least one medical access opening.

### 2. Description of Related Art

Horse garments such as a horse slinky are snug fitting wraps that cover a horse's head and shoulders. Some are shoulder length and only go over the horse's front shoulders, and others are full-body, extending over the horse's hind quarters. Both versions wrap under the horse's chest so that the side portions can be attached to each other. The slinky has openings for the horse's eyes, nose, and ears. Some have zippers and some are just one-piece. Either way, the slinky must be pulled over and positioned on the horse's head.

However, when a vet needs access to the horse's neck to administer medicine, the vet must undo the slinky and pull it over the horse's head, so that the vet can have access to the horse's neck. This takes time and adds to the horse's anxiety. The medicine is often in either IV (intravenous) form or IM (intramuscular) form. The IV injections are often made in the horse's jugular veins, which are located along the underneath portion of the horse's neck. The IM injections are often made in the horse's neck muscles, which are located along the upper portion of the horse's neck. Accordingly, an improved design for a horse garment would be desirable.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1A is a front perspective view of an equine wrap with medical access openings with zippers in closed positions according to a preferred embodiment of the present application;

FIG. 1B illustrates the medical access openings of FIG. 1A with the zippers in open positions;

FIG. 2 illustrates a cover for each zipper;

FIG. 3A illustrates medical access openings that include flaps with hook and loop fasteners, in closed positions;

FIG. 3B illustrates the flaps of FIG. 3A in open positions;

FIG. 4 illustrates a flapped opening at a rear section of the equine wrap;

FIG. 5 illustrates flapped openings with snap fasteners;

FIG. 6 illustrates flapped openings with magnetic fasteners;

FIG. 7 illustrates a pouch that is adjacent to the openings; and

FIG. 8 illustrates an equine wrap without a head cover.

While the assembly of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of an equine wrap with one or more medical access openings according to the present application are provided below. It will of course be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

In this specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

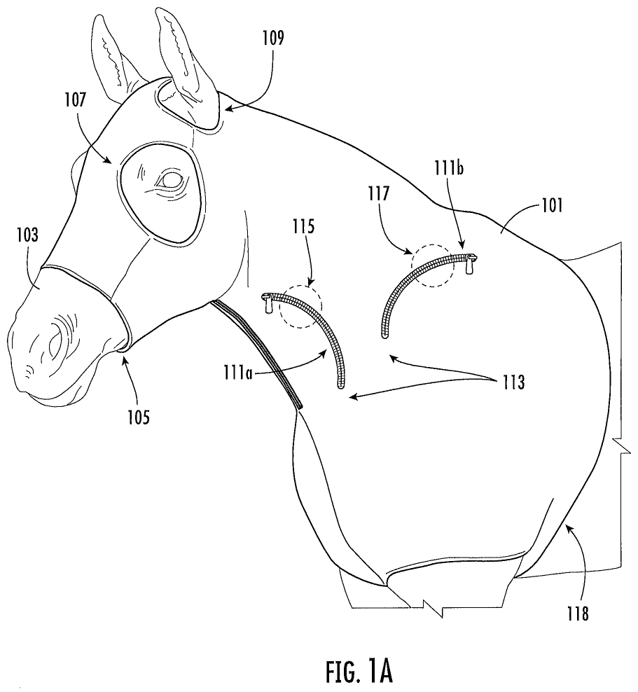

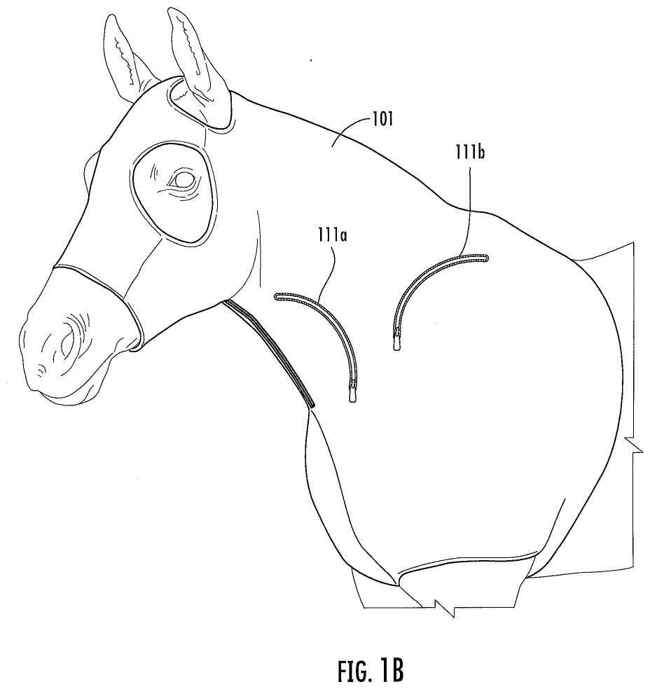

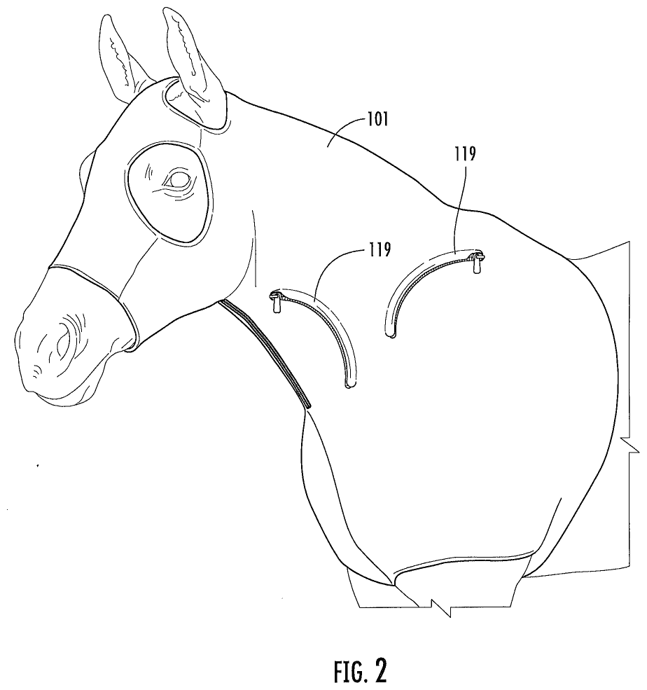

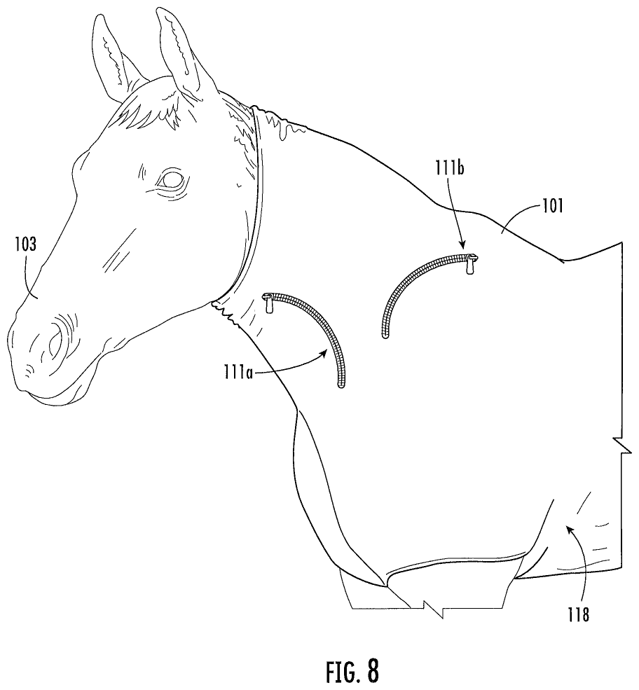

Referring now to FIGS. 1A-2 in the drawings, a horse garment is illustrated according to a preferred embodiment of the present application. The horse garment may include an equine wrap 101. The equine wrap 101 may cover at least a section of the horse 103. In some embodiments, the equine wrap 101 may cover the front end of the horse 103 including portions of the head, face, and shoulders. In other embodiments, the equine wrap 101 may extend the entire length of the horse or cover only a portion such as the hind quarters, for example. In other embodiments, the equine wrap 101 ends at the head of the horse (i.e., no head cover), as best shown on FIG. 8.

The equine wrap 101 may include a fabric that includes a snout hole 105, eye holes 107, and ear holes 109. The equine wrap 101 may include one or more medical access openings such as openings 111a (e.g., lower opening) and 111b (e.g., upper opening). Each of the openings may expose a portion of the horse 103 for medical treatment. In some embodiments, each opening may include a zipper 113 for opening or closing. There may be one or more openings on one or both sides at the horse's neck and/or hind quarters. The openings may be holes or slits located at particular positions along the horse's neck and/or hind quarters. The openings may be curved, slanted, horizontal, or vertical.

The opening 111a may be positioned on the equine wrap 101 to align with an IV location 115 such as the horse's jugular veins, which are located along the underneath portion of the horse's neck. The opening 111b may be positioned on the equine wrap 101 to align with an IM location 117 such as the horse's neck muscles, which are located along the upper portion of the horse's neck.

FIG. 1A shows each opening in a closed position/zipped shut. FIG. 1B shows the openings 111a and 111b open/unzipped. The openings may be positioned on a front section 118 of the equine wrap 101. The equine wrap 101 may include contours to snugly fit/conform to the shape of the horse. The openings may include various shapes and may be zipped/unzipped in different directions (e.g., up, down, left, right). The openings may be placed on either or both sides of the equine wrap 101. In some embodiments, the openings may include zipper covers 119 to keep debris out, as best shown on FIG. 2.

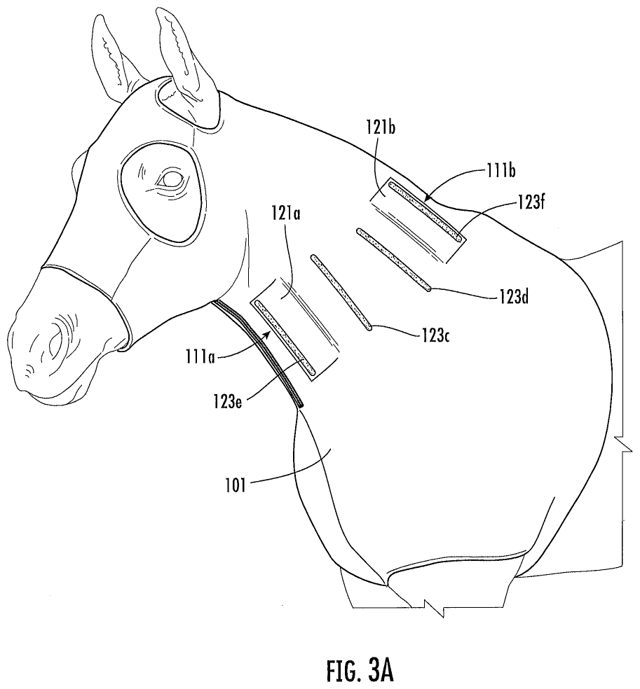

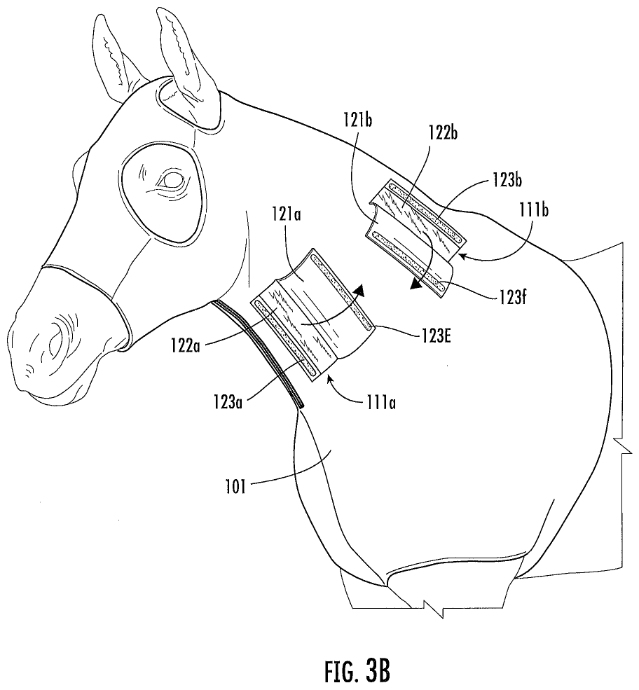

With additional reference to FIGS. 3A and 3B, the openings 111a and 111b may include flaps 121a and 121b, respectively. Fasteners 123a, 123b, 123c, and 123d (e.g., hook and loop fastening strips) may be positioned adjacent to each opening to secure each flap in an open or closed position. FIG. 3A illustrates the flaps 121a and 121b closed. FIG. 3B illustrates the flaps 121a and 121b opened exposing portions 122a and 122b of the horse for medical treatment. Each flap may open or close in various directions (e.g., left, right, up, down). The flaps 121a and 121b may also include fasteners 123e and 123f (e.g., hook and loop fastening strips), respectively. The fasteners 123e and 123f may be on both sides of the flaps (e.g., double-sided) to allow for securing the flaps in open or closed positions.

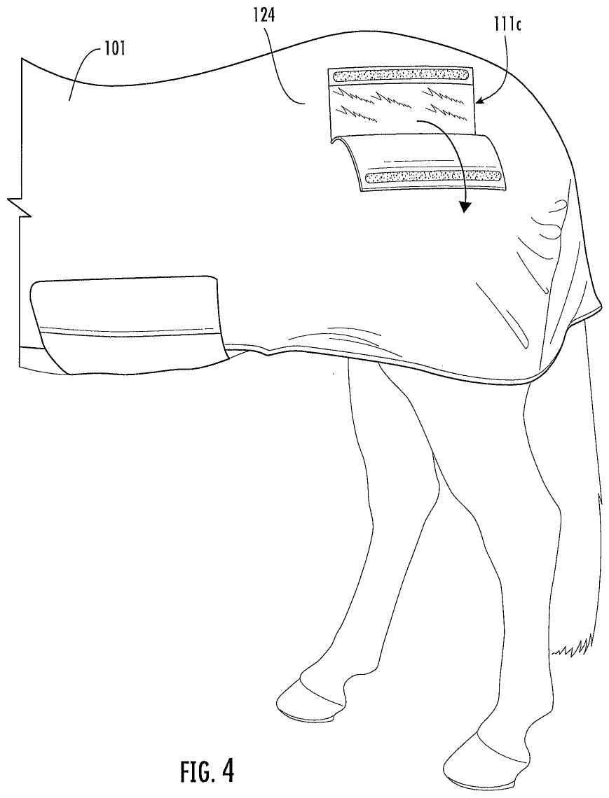

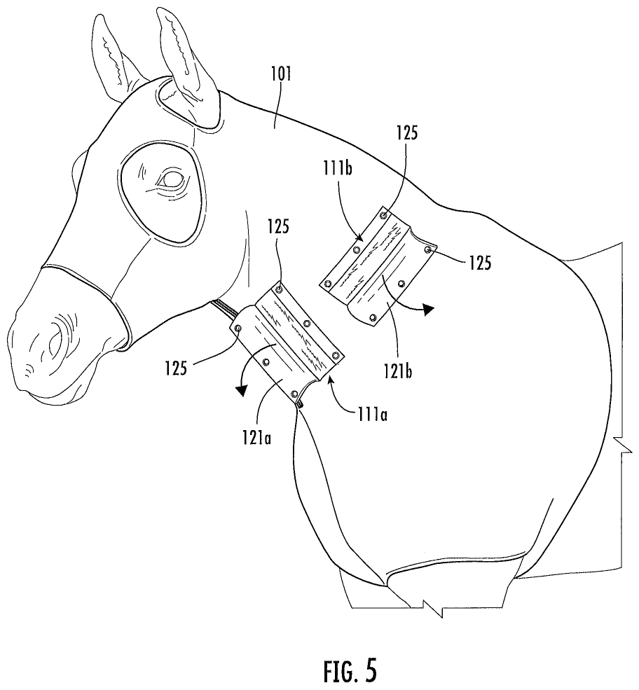

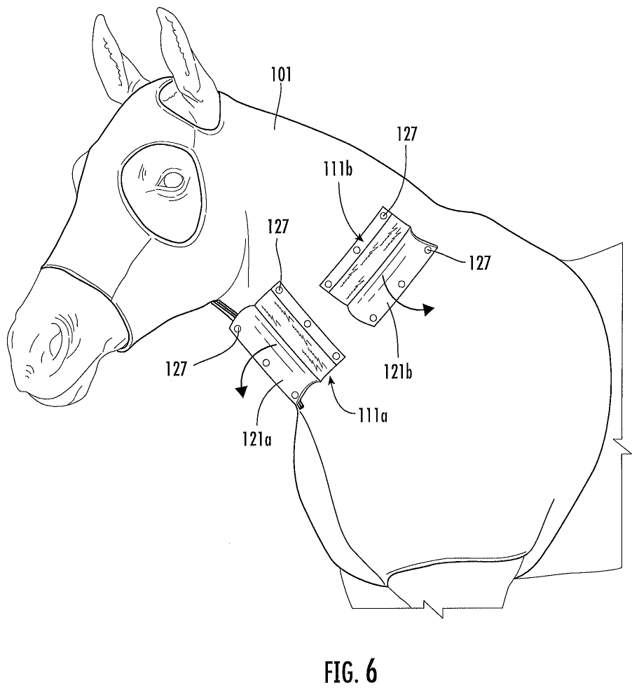

With additional reference to FIG. 4, an opening 111c may be positioned on a rear section 124 of the equine wrap 101. The opening 111c may be positioned on the rear section to align with the hind quarters of the horse. The opening 111c may be configured similar to the other openings with fasteners. FIG. 5 illustrates fasteners such as snap fasteners 125 to secure the flaps 121a and 121b in open or closed positions. The snap fasteners 125 may be arranged similar to the other fasteners as described herein. FIG. 6 illustrates fasteners that include magnets 127. The magnets 127 may be arranged similar to the other fasteners as described herein. In some embodiments, a vertical flap may be positioned to align with the mid to lower neck regions of the horse.

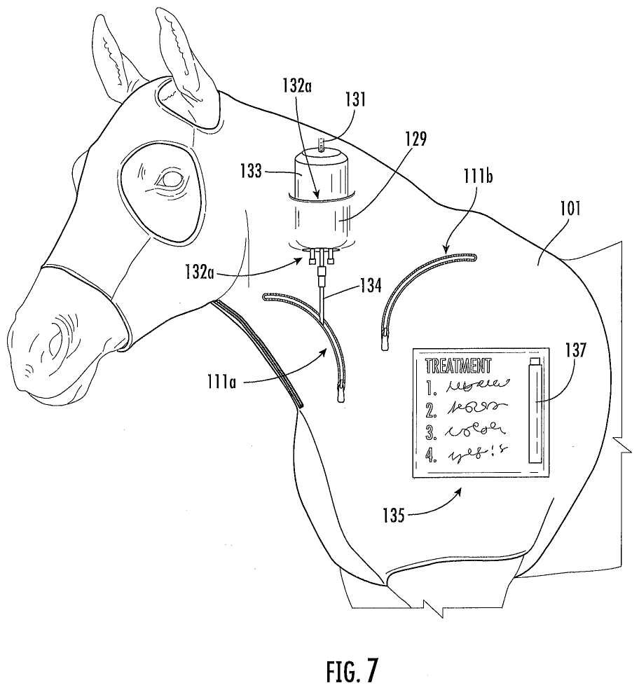

FIG. 7 illustrates a pouch 129 positioned on the equine wrap 101. A clip 131 may secure an IV bag 133 (or bottle) in the pouch 129. In some embodiments, a post may be fastened to the equine wrap for carrying the IV bag. The pouch 129 may be adjacent to the opening 111a and/or 111b. The pouch 129 may include an opening 132a at the top and an opening 132b at the bottom for passage of medical equipment 134 such as an IV line that may enter an opening. The equine wrap 101 may include a writing surface 135 with a writing utensil 137 (e.g., white board and dry-erase marker adjacent to an opening) for writing down medical treatment information pertaining to the horse.

It is apparent that a system with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. An equine wrap comprising:
a fabric including contours that conform to a shape of a horse;
at least one medical access opening positioned in the fabric to align with an intravenous location of the horse; and
at least one fastener adjacent to the at least one medical access opening;
wherein the fabric comprises:
a snug fitting wrap having opposing sides that wrap completely around the horse and are configured to attach to each other under a chest of the horse.

2. The equine wrap according to claim 1, further including a second medical access opening positioned in the fabric to align with an intramuscular location of the horse.

3. The equine wrap according to claim 1, wherein the at least one fastener includes a zipper.

4. The equine wrap according to claim 1, further including a flap adjacent to the at least one medical access opening.

5. The equine wrap according to claim 4, wherein the flap includes a magnet.

6. The equine wrap according to claim 4, wherein the flap includes a snap fastener.

7. The equine wrap according to claim 4, wherein the flap includes a hook and loop fastener.

8. The equine wrap according to claim 1, further including a pouch adjacent to the at least one medical access opening.

9. The equine wrap according to claim 8, wherein the pouch includes two openings.

10. The equine wrap according to claim 8, wherein the pouch includes a clip.

11. An equine wrap comprising:
a fabric including contours that conform to a shape of a horse;
a first medical access opening positioned in a front section of the fabric to align with an intravenous location of the horse;
a second medical access opening positioned in the front section of the fabric to align with an intramuscular location of the horse; and
fasteners adjacent to each medical access opening;
wherein the fabric comprises:
a snug fitting wrap having opposing sides that wrap completely around the horse and are configured to attach to each other under a chest of the horse.

12. The equine wrap according to claim 11, further including a third medical access opening positioned in a rear section of the fabric.

13. The equine wrap according to claim 11, wherein each fastener includes a zipper.

14. The equine wrap according to claim 13, further including a cover adjacent to each zipper.

15. The equine wrap according to claim 11, further including a flap adjacent to each medical access opening.

16. The equine wrap according to claim 15, wherein the flap includes a hook and loop fastener.

17. The equine wrap according to claim 15, wherein the flap includes a snap fastener.

18. The equine wrap according to claim 15, wherein the flap includes a magnet.

19. The equine wrap according to claim 11, wherein the first medical access opening is positioned on the fabric below the second medical access opening and aligned with an underneath portion of a neck of the horse;
and wherein the second medical access opening is positioned on the fabric to align with an upper portion of the neck of the horse.

20. The equine wrap according to claim 11, further including a pouch adjacent to at least one medical access opening, wherein the pouch includes two openings to pass medical equipment into the at least one medical access opening.
